(19) United States
(12) Patent Application Publication
(10) Pub. No.: US 2025/0188309 A1
(43) Pub. Date: Jun. 12, 2025

(54) SYNTHETIC MATERIAL AND METHOD OF MANUFACTURING THE SAME

(71) Applicant: Magnekon, S.A. de C.V., Nuevo León (MX)

(72) Inventors: Juan Carlos MORALES HUERTA, Nuevo León (MX); Edgar Alberto DUARTE PEÑA, Nuevo León (MX); Francisco DÍAZ CAMACHO, Nuevo León (MX)

(21) Appl. No.: 18/532,195

(22) Filed: Dec. 7, 2023

(51) Int. Cl. C09D 175/08; C09D 7/61

(52) U.S. Cl. CPC C09D 175/08; C09D 7/61

(57) ABSTRACT

A synthetic material with properties similar to wood, and, moreover, surpasses limitations in both mechanical (mechanical properties and strength) and chemical resistance (exposure and/or function in corrosive or highly corrosive environments) found in traditional wood material. The synthetic material is obtained by combining sawdust waste with a polyurethane-based resin, resulting in a product that mimics the mechanical characteristics of wood. The manufacturing process includes preparing a mixture that incorporates polyethylene glycol of different molecular weights, sawdust, inorganic fillers, a defoamer, and a catalyst. This mixture is subsequently combined with Polymeric Methyl Diisocyanate (Polymeric MDI) in different proportions, according to the desired properties for the final material. The product may be poured into molds and used to manufacture “staves” that find applications in various industries and fields.

### FIELD OF THE INVENTION

This invention relates to the field of synthetic materials with properties similar to wood and the methods for manufacturing them. In particular, the present invention focuses on a synthetic material that mimics the mechanical characteristics of wood, created by combining sawdust waste and a polyurethane-based resin, along with the involved method for its fabrication.

### BACKGROUND OF THE INVENTION

Conventional wood has long been an essential material in the construction materials industry and various industrial applications due to its availability, natural properties, and renewable nature. However, despite its advantages, technologies relying on conventional wood have faced notable technical challenges that have limited their effectiveness and durability in certain contexts.

One of the most outstanding technical problems pertains to the poor mechanical properties of conventional wood. As industrial applications have evolved and demanded materials with exceptional mechanical properties, wood has proven insufficient in terms of moisture resistance, compression, torsion, and other mechanical loads. This has resulted in fungal deterioration, deformations, fractures, and excessive wear of wood components, limiting its viability in critical applications.

Furthermore, an equally important technical issue is related to the low resistance of wood to weather conditions. Constant exposure to adverse environmental factors such as solar radiation, rain, wind, and humidity has proven detrimental to conventional wood. This lack of resistance to environmental conditions can lead to substantial deterioration in the integrity of wood structures and components, resulting in additional maintenance costs and a limited or reduced lifespan.

Given that technologies based on conventional wood remain essential in many industrial applications, it is known that different technologies have emerged offering materials with variations in their mechanical properties and overall resistance to weather conditions. An example is the U.S. Pat. No. 11,142,616 B2 published on Apr. 11, 2017, which describes a specific process used in the production of a material known as “pultruded.” This process involves multiple stages and the combination of different components to create a resin system used in the pultrusion process. As an expert in the field or a person with ordinary skill in the art will know, pultrusion is a manufacturing method in which fiber materials, such as glass or carbon fibers, are reinforced with resin to produce long and sturdy profiles or pieces. Based on the aforementioned and in accordance with the disclosure in the aforementioned US'616 patent, the process begins by mixing di- or polyisocyanates with compounds having at least two reactive groups towards isocyanates, catalysts, and mold release agents to facilitate the extraction of parts from the mold after the curing process. Additionally, according to the US '616 patent, other auxiliaries and additional substances can be optionally added to adjust the properties of the resulting material.

However, while the resulting material from the teachings of the US '616 patent offers improved mechanical properties compared to conventional wood, it is known that pultrusion and, particularly, the use of glass or carbon fibers as reinforcement, combined with resin, present certain notable deficiencies. Firstly, the pultrusion process is inherently complex, requiring highly specialized and costly operation. Additionally, the use of glass or carbon fibers involves higher material and energy consumption, resulting in significant costs and increased environmental impact. Furthermore, the specialized operation required for pultrusion limits its applicability to certain industrial contexts.

Moreover, the use of the pultrusion process as described in the US '616 patent does not allow obtaining a material with exceptional mechanical properties and weather resistance that are increasingly demanded in a wide range of industrial applications.

On the other hand, the U.S. Pat. No. 6,416,696 B1 published on Jul. 9, 2002, describes a process for manufacturing wood composite products. This process involves combining wood particles with a binder composition and subsequently forming this resulting mixture through molding or compression.

The binder compositions used in the process according to US '696 Patent consist of two main components. The first is an aqueous dispersion of a blocked polyisocyanate component, which has been chemically modified to prevent premature reaction with other components, making it especially suitable for use in this application. This aqueous dispersion is mixed with the second component, which is an aqueous solution of a phenolic resin.

Together, these two components of the binder composition according to US '696 Patent generate a mixture that binds the wood particles during the manufacturing process. The process itself involves combining wood particles with the aforementioned binder composition, with the formation of the final mixture taking place through molding or compression, generally at specific pressures and controlled temperatures, creating wood composite products with certain strength and durability characteristics.

However, while the wood composite products disclosed in the US '696 patent offer some increase in mechanical properties compared to conventional wood, it can be noted that this approach is based on a combination of wood particles with a specific binding composition. A person with ordinary skill in the art will determine that this process may have limitations in terms of variability and control of the properties of the final product, with this lack of stability in the process outcome being a relevant constant that would hinder obtaining a qualified or reliable material with desirable mechanical properties and sufficient weather resistance.

Additionally, the publication titled “Paving the Way for the Next Generation of Residential Coating,” belonging to Baydur and available for public consultation since 2015, describes a process called LFT (Long Fiber Thermoplastics). In this process, long glass fibers, typically ranging from 12.5 mm to 100 mm, are usually cut and combined with polyurethane resin, with this union achieved through a mixing head located at the end of a robotically programmed arm dispensing the material into a specifically designed mold, shaping the final or target piece.

The products obtained through the LFT process according to the aforementioned publication replicate intricate details in the mold, resulting in a finish that resembles real wood. Moreover, this process allows the creation of sealed joints in the panels, avoiding the need for caulking.

However, like the material generated by the aforementioned US '616 patent, the technology disclosed in this publication requires the use of glass fibers combined with a polyurethane resin. While this technology allows replicating some intricate details and offering resistance to moisture, rot, and decay, it does not meet the need to obtain a material with exceptional mechanical properties and outstanding resistance to adverse environmental conditions, limiting it in certain industrial contexts.

Furthermore, within the prior art, the U.S. Pat. No. 9,688,056 B2, published on Mar. 26, 2015, is known, which describes various examples related to the creation of polymer-reinforced composite plywood. The '056 patent addresses the development of a composite plywood material with improved impact resistance, focusing on enhancing composite panels used primarily in the ready-to-assemble furniture (RTA) market, with a specific focus on low-pressure laminates (LPL) and high-pressure laminates (HPL).

The polymer-reinforced composite plywood according to the '056 patent includes a multilayer polymeric film bonded to a first layer of wood veneer and a second layer of wood veneer. In another example, the '056 patent discloses a polymer-reinforced composite plywood comprising a monolithic polymeric film bonded to a first layer of wood veneer and a second layer of wood veneer. Additionally, a second monolithic polymeric film can be adhered to the second layer of wood veneer and a third layer of wood veneer. In another example, the low-pressure laminate includes a polymeric film layer bonded to a base layer that forms a protective laminating layer over the base layer.

Based on the above, a person with ordinary skill in the art will notice that the invention described in the '056 patent presents significant advances in the creation of polymer-reinforced composite plywood. However, despite the improvement in impact resistance and effective protection, the resulting composite materials fail to provide the desired mechanical properties and desirable resistance to corrosive or weather environments in critical industrial applications. Often, these limitations make products based on this technology unsuitable for applications requiring a material with superior mechanical properties and exceptional resistance to adverse environmental conditions.

Furthermore, the U.S. Pat. No. 8,663,414B2 is known within the state of the art, describing an invention focused on a resin system specifically designed for the pultrusion process using (a) di- or polyisocyanates: which, as a person with ordinary skill in the field to which this invention belongs will know, allow the formation of the molecular structure of the material, as well as provide a certain strength and mechanical characteristics; (b) Compounds with at least two groups reactive towards isocyanates, which interact with isocyanates to create links that strengthen to some extent the structure of the material and, thereby, its resistance capacity; (c) catalyst, which triggers and accelerates chemical reactions for the formation of the pultruded material; (d) Polybasic acid with functionality equal to or greater than 2, fundamental in the stability of the resulting material, and depending on whether said acid has a boiling point of at least 200°° C. at standard pressure and is soluble in the compound containing groups reactive towards isocyanates, allows the obtainment of a material with desired properties.

Once again, the deficiency in generating a stable material derived from the composition it is made of is notable, particularly, the resin system as disclosed in the US '414 patent would not allow obtaining a material with desired mechanical properties and exceptional resistance to corrosive or challenging environmental conditions due to the complexity of its methodology and the potential instability derived from the conditions that must be met for each of the discussed components to be effectively mixed. This limitation restricts its applicability in certain industrial applications that demand high-performance materials.

Additionally, the US Patent Application No. US20210032423 A1, published on Feb. 4, 2021, discloses processes for manufacturing a fiber-reinforced polyurethane composite, with stages including (a) continuously pulling a continuous fiber reinforcement cord or wick through an impregnation chamber and a nozzle successively; (b) continuously supplying a reactive polyurethane-forming mixture to the impregnation chamber; (c) the fiber reinforcement material comes into contact with the reactive polyurethane-forming mixture in the impregnation chamber, achieving at least partial wetting of the material through the formulation; (d) the fiber reinforcement material is directed through a nozzle heated to the reaction temperature to form a solid composite; (e) finally, the composite is extracted from the nozzle.

Furthermore, the patent application '423 discloses that, within the aforementioned process, the reactive polyurethane-forming mixture comprises: (i) a polyisocyanate; (ii) a polyol; (iii) A catalyst composition including a chelated organometallic/metalorganic catalyst.

Similar to the previously discussed technology, the proposal laid out in the patent application '423 again exposes the manufacturing of fiber-reinforced polyurethane compounds with the aim of offering improvement in their mechanical and weather resistance properties. However, as mentioned earlier, the use of fibers in a resin mixture is an option that still creates areas of opportunity and desirable properties, especially for industrial applications requiring highly resistant materials.

Based on the teachings of the prior art, it is clear that, to date, alternatives or proposals focused on the development of materials resembling wood properties and offering efficient mechanical properties and resistance to corrosive environments (weather) primarily center on the use of mixtures of glass or carbon fibers (in different portions or sections or even in large segments) mixed with resin or, as inferred from the aforementioned, through the pultrusion process. Both methods are unreliable due to the potential instability of the resulting material if a component is not processed within a control range or due to the complexity of the process itself or the large number of elements required to achieve the desired mixture and material.

Therefore, there is a need to provide a material, particularly a synthetic material, that overcomes, firstly, the inherent limitations of conventional wood, and additionally, offers a more efficient, reliable, and safe alternative that involves a reduced use of resources. This, in turn, results in a material with superior and optimal mechanical properties, as well as desirable resistance to weather conditions, thereby substantially enhancing the performance of said material in a wide range of industrial applications.

Furthermore, there is a need to provide a methodology for generating the aforementioned material with the desired characteristics and properties for a highly demanding industrial application. This method is particularly desired to be substantially more efficient, simpler, controlled, and safe, directly enabling the production of a material with the previously indicated capabilities.

### SUMMARY OF THE INVENTION

It is therefore an objective of the present invention to provide a material, particularly a synthetic material that mimics the traditional characteristics of wood and, additionally, surpasses limitations in both mechanical (mechanical properties and strength) and chemical resistance (exposure and/or function in corrosive or highly corrosive environments).

The aforementioned objective pursued by the present invention aims to ensure that the developed synthetic material offers an effective and versatile solution for a variety of industrial applications and can be applied or is applicable to a plurality of functions, derived from its explicit improvement in mechanical strength and component durability, while offering increased resistance to adverse environmental conditions.

More particularly, an object of the present invention is to provide a material, particularly a synthetic material comprising a specific combination of Polyethylene Glycol of different molecular weights and a waste material, particularly, reused material from the reel manufacturing industry, which is sawdust obtained from the production of such wooden reels, inorganic fillers such as calcium hydroxide, kaolin, and calcium carbonate, defoamer, and catalyst in precise proportions, together with polymeric MDI, with the purpose that, derived from the combination of the aforementioned components, this overall interaction of components results in a novel and innovative, substantial, advantageous improvement in at least mechanical properties and resistance to corrosive environments, compared to known materials within the state of the art.

Likewise, an object of the present invention is to provide a novel method, which, as a result of the implementation of its sequence of steps and/or stages, results in and/or allows the generation of a material, particularly, a synthetic material; said synthetic material having the aforementioned improvements.

On the other hand, as a result of generating a synthetic material based on the proposed composition and methodology, the object of the present invention, an additional object of the present invention is, by way of example of use and/or an example of embodiment, to provide, from the synthetic material, a plurality of staves, understood within the context of this application as “staves” as defined segments, commonly characterized within the relevant field, as rectangular bodies (however, other shapes may be adopted without departing from the teachings of this application).

Finally, the present invention further aims to provide, from the staves generated based on the proposed composition and methodology, the object of the present invention, as an additional example of use and/or an additional example of embodiment, a cable storage reel, which, due to the high-efficiency mechanical properties and resistance to corrosive environments of the synthetic material resulting from the present invention, said reel offers a superior alternative compared to reels made solely of wood or polymeric material known within the state of the art.

### BRIEF DESCRIPTION OF THE DRAWINGS

FIG. 1 depicts a schematic diagram illustrating the method for preparing a mixture and generating a resin in accordance with the present invention.

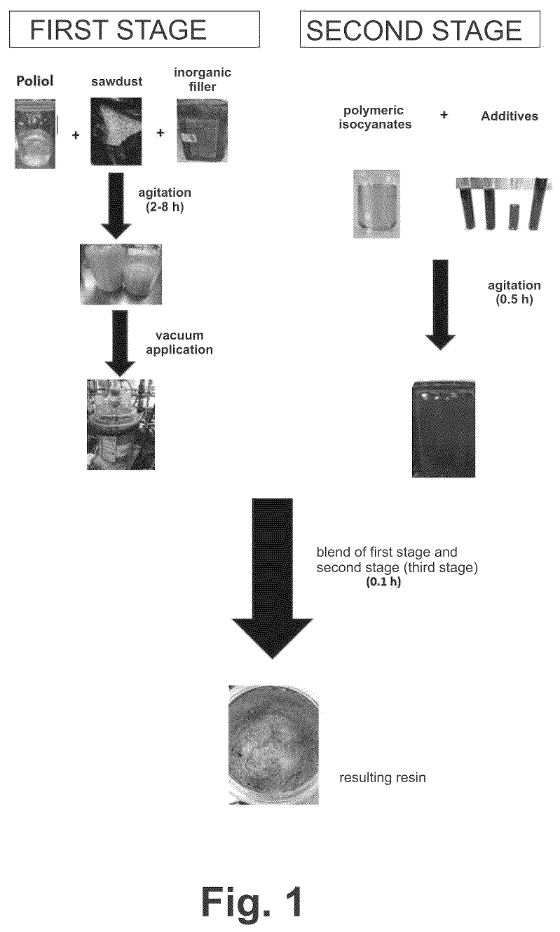

FIG. 2 illustrates a schematic diagram depicting a method for preparing a synthetic

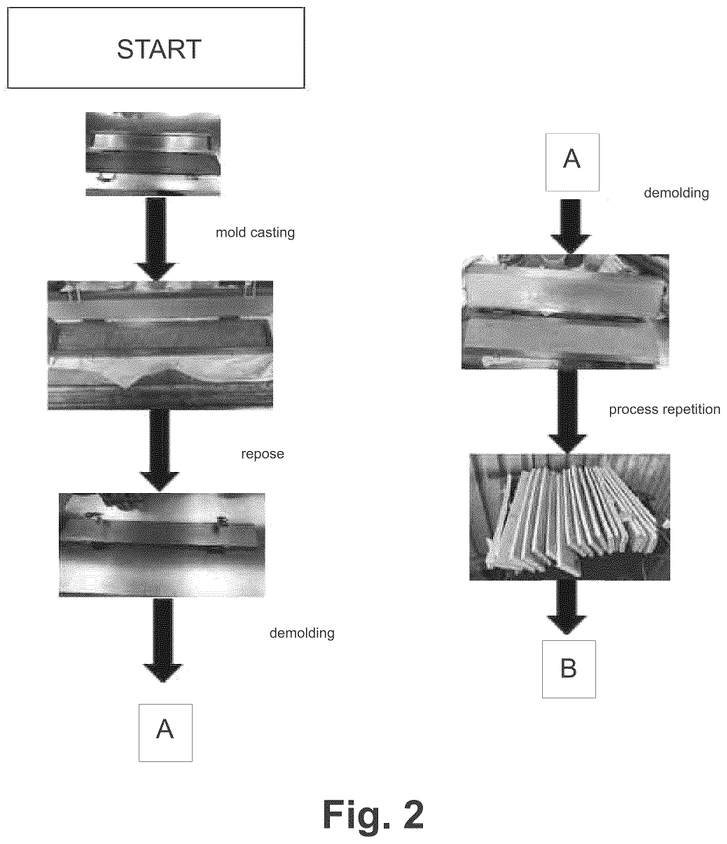

stave, according to an exemplary embodiment, using the resin in accordance with the present invention.

FIG. 3 presents a schematic diagram illustrating a method for preparing a composite reel made of synthetic stave, in accordance with an exemplary embodiment of the present invention.

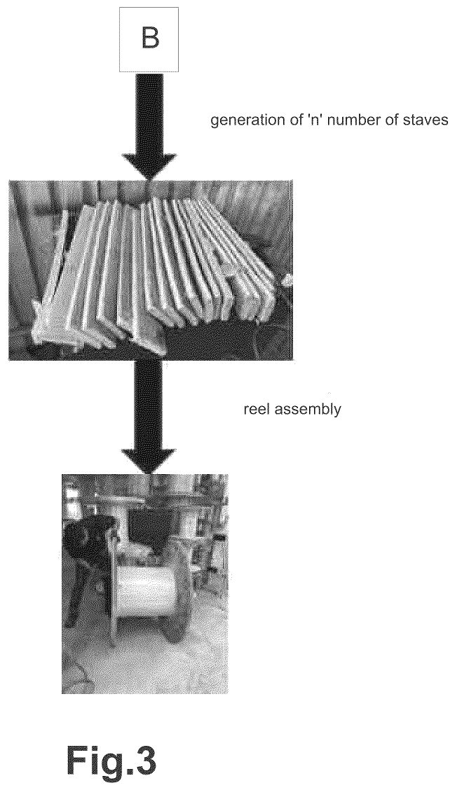

FIG. 4 showcases experimental tests conducted on the synthetic stave generated from the resin in accordance with the present invention.

FIG. 5 displays the experimental tests conducted on the composite reel made of synthetic stave according to an exemplary embodiment of the present invention.

### DETAILED DESCRIPTION OF THE INVENTION

Some aspects of the present invention will now be described in more detail with reference to the accompanying drawings, which illustrate some embodiments and advantages of the present invention. For one skilled in the art, it will be apparent that various embodiments of the invention can be expressed in different forms and should not be interpreted as limited to the embodiments described herein; rather, these exemplary embodiments are provided to make this invention clear and complete and to fully convey the scope of the invention to those skilled in the art. For example, unless otherwise indicated, something described as first, second, or similar should not be interpreted as a particular order. As used in the description and in the appended claims, singular forms “a, an,” “the,” include plural referents unless the context clearly indicates otherwise.

Different aspects of the present invention relate to a synthetic material with properties similar to wood, and, moreover, surpassing limitations in both mechanical (mechanical properties and strength) and chemical resistance (exposure and/or function in corrosive or highly corrosive environments) present in traditional wood material. The synthetic material, according to the present invention, is obtained by combining sawdust waste with a polyurethane-based resin, resulting in a product that mimics the mechanical characteristics of wood. The manufacturing process according to the present invention includes preparing a mixture incorporating polyethylene glycol of different molecular weights, sawdust, inorganic fillers, an antifoaming agent, and a catalyst. This mixture is subsequently combined with Polymeric Methyl Diisocyanate (Polymeric MDI) in different proportions, depending on the desired properties for the final material. The product is poured into molds and used to manufacture “staves” that find applications in various industries and fields.

Furthermore, the present invention relates to, once the aforementioned “staves” are generated, generating and/or providing, by way of non-limiting example, a reel commonly used in the cable generation industry. This reel, when manufactured using synthetic material staves according to the present invention, comprises mechanical properties and resistance to corrosive environments that are evidently superior to reels currently used in the field, that is, reels made exclusively of traditional wood and/or reels made from a thermoplastic material.

Additionally, the present invention relates to an associated methodology for generating, first, a mixture that can be characterized as a resin, which, as will be evident from a holistic reading of this application, such resin, derived from the components, proportions, and/or ranges and, in general, the overall interaction between each of the aforementioned components, generates a resin that, when cast in a specific mold, can generate a piece or element that resembles traditional wood but with significantly superior mechanical properties and resistance to corrosive environments.

The aforementioned method is intended to, regardless of the characteristics of the mold to be used, form the mixture or resin, from which a product is generated with superior mechanical properties and resistance to corrosive environments.

Composition of elements in the mixture According to one embodiment of the present invention, the synthetic material that mimics wood properties can be generated by combining two main components: waste material remnants; in particular, according to the embodiment, reused material from the reel manufacturing industry, which is sawdust obtained from manufacturing such wooden reels, and a polyurethane-based resin.

In one embodiment, the granulated waste material or in a kind of granule, in particular, sawdust, may be present in proportions in a range from 20% to 60%. In this sense, “granulated or in a kind of granule” should be understood that the material may be presented in granulated form with the presence of small solid particles or granules of a particular substance. These granules are tiny fragments and can vary in shape and size. In general, by “granule,” it should be understood, for the present application, as a fine granule that is larger particles than dust but still in the range of fine sizes. They can be felt between the fingers but remain small and generally imperceptible to the naked eye, or medium-sized granules, which are medium-sized particles that are more noticeable to the naked eye and can give a distinctive texture to the solid material.

According to one embodiment, the waste material can be sawdust from pinus duranguensis or pinus echinata wood, with a moisture content between 5% and 10%, lignin content between 20% and 25%, hemicellulose between 20% and 25%, and cellulose between 40% and 45%, with a micrometric particle size, with pH: 7 {note} More specifically, the aforementioned polyurethane-based resin, according to the embodiment of the present invention, may be formed from materials and components selected from the group comprising: polyethylene glycol, inorganic fillers such as calcium hydroxide (CaOH), Kaolin, Calcium Carbonate (CaCO3); antifoaming agent and a catalyst, Polymeric Methyl Diisocyanate (Polymeric MDI) and MDI Polymeric, combinations thereof, and/or the like. According to a preferred embodiment, the polyethylene glycol present in the

polyurethane-based resin according to the present invention may be polyethylene glycol with different molecular weights; particularly, it may be polyethylene glycol with a molecular weight at a value of approximately 300, approximately 600, and/or approximately 1000 g/mol.

In the context of this application, “approximately” should be understood or interpreted that values denoted with this term can be exactly those values (exactly 300, exactly 600, exactly 1000 g/mol) or these values can have a variation in a range from 1% to 5%, with the foregoing, a person of ordinary skill in the art will understand that any value within the previously indicated ranges would be within the scope and spirit of the present invention). In an additional embodiment, the polyurethane-based resin according to the present

invention may comprise inorganic fillers from 10% to 30% such as any selected from the group comprising calcium hydroxide (CaOH), Kaolin, Calcium Carbonate (CaCO3), combinations thereof, and/or the like.

In one embodiment, the polyurethane-based resin according to the present invention may further comprise an antifoaming agent and a catalyst; in a more particular embodiment, the antifoaming agent may be any selected from the group comprising silicone-based and polysiloxane emulsions; on the other hand, in a more particular embodiment, the aforementioned catalyst may be any selected from the group comprising organometallic, amino, and metal-free organic types.

Also, according to one embodiment, the aforementioned antifoaming agent may be present in an amount and/or proportion of less than 1%, for example, in a proportion of approximately 1%, approximately 0.90%, approximately 0.80%, approximately 0.7%, approximately 0.6%, approximately 0.5%, approximately 0.4%, approximately 0.3%, approximately 0.2%, approximately 0.1%, or even less than 0.1%.

On the other hand, according to one embodiment, the aforementioned catalyst may be present in an amount and/or proportion less than 1%, for example, in a proportion of approximately 1%, approximately 0.90%, approximately 0.80%, approximately 0.7%, approximately 0.6%, approximately 0.5%, approximately 0.4%, approximately 0.3%, approximately 0.2%, approximately 0.1%, or even less than 0.1%. In an optional embodiment, the catalyst may be in the same amount and/or proportion as the antifoaming agent. In another optional embodiment, the catalyst may be in a completely different amount and/or proportion than that of the antifoaming agent.

In the mentioned embodiment, the polyurethane-based resin according to the present invention may also comprise Polymeric Methyl Diisocyanate (Polymeric MDI) in a proportion ranging from 16% to 30%; in another embodiment, it may comprise from 70% to 84%, depending on the desired final properties for the stave.

The inventor has discovered that the relationship between polyol and polymeric MDI plays a crucial role in determining mechanical properties such as flexibility, compression resistance, and toughness, as well as the final density of the stave generated with the resin according to the present invention. This direct interaction between components essentially defines the quality and performance of the resulting material.

When there is an excess of polymeric MDI, increased porosity is induced in the material, leading to increased fragility and a significant loss of flexibility properties. On the other hand, an excess of polyol causes increased flexibility in the stave but with the drawback of not achieving the desired compression resistance.

Based on the above, the inventor has found an appropriate ratio between these two components, thereby achieving an optimal balance between flexibility and strength. Precise adjustment will not only maximize the toughness of the material but also directly influence the final density of the stave, thus ensuring a final product that meets desired performance standards and offers exceptional durability.

Mixing Methodology According to one embodiment, the manufacturing process of the mixture in the present invention comprises several stages that are essential for obtaining a high-quality synthetic material with the mechanical properties and resistance to corrosive environments as mentioned throughout this application.

In one embodiment, the process includes the steps of: First stage (A) a mixture is prepared in a closed container with controlled vacuum of 4

liters. This mixture is a precise combination of components that play a crucial role in the formation of the material. In one embodiment, such a mixture may include polyethylene glycol of different molecular weights, particularly polyethylene glycol with a molecular weight at a value of approximately 300, approximately 600, and/or approximately 1000 g/mol. (In the context of this application, “approximately” should be understood or interpreted that values denoted with this term can be exactly those values or those values can have a variation in a range from 1% to 5%, with the foregoing, a person of ordinary skill in the art will understand that any value within the previously indicated ranges would be within the scope and spirit of the present invention). (B) after the application of Polyethylene Glycol, waste material is incorporated, especially sawdust, whose proportion may be present in proportions in a range from 20% to 60%. Sawdust contributes unique characteristics to the material, enhancing its strength and durability, in addition to reusing waste material from another process, achieving circular economy. (C) inorganic fillers such as any selected from the group comprising calcium hydroxide (CaOH), Kaolin, Calcium Carbonate (CaCO3), combinations thereof, and/or the like are added. These inorganic fillers play a fundamental role in improving properties such as impact resistance and material stiffness; in one embodiment, the amount of inorganic fillers added to the mixture according to the present invention can be any in a range from 10% to 30%. (D) an antifoaming agent and a catalyst are added to the mixture to control the formation of unwanted bubbles during the process; in one embodiment, the aforementioned antifoaming agent may be present in an amount and/or proportion less than 1%, for example, in a proportion of approximately 1%, approximately 0.90%, approximately 0.80%, approximately 0.7%, approximately 0.6%, approximately 0.5%, approximately 0.4%, approximately 0.3%, approximately 0.2%, approximately 0.1%, or even less than 0.1%; on the other hand, according to one embodiment, the aforementioned catalyst may be present in an amount and/or proportion less than 1%, for example, in a proportion of approximately 1%, approximately 0.90%, approximately 0.80%, approximately 0.7%, approximately 0.6%, approximately 0.5%, approximately 0.4%, approximately 0.3%, approximately 0.2%, approximately 0.1%, or even less than 0.1%. In an optional embodiment, the catalyst may be in the same amount and/or proportion as the antifoaming agent. In another optional embodiment, the catalyst may be in a completely different amount and/or proportion than that of the antifoaming agent. (E) once the aforementioned components are incorporated, the resulting mixture can be subjected to high-speed agitation; in one embodiment, “high speed” should be understood that such agitation can take place at a speed of approximately 1000 rpm; in another embodiment, agitation can take place in a speed range from 700 rpm to 1200 rpm; the referred agitation process can take place for an approximate period ranging from two to eight hours; in a preferred embodiment, the referred agitation process can take place for an approximate period ranging from three to five hours. This agitation step ensures homogeneity and effective interaction of the components.

Second stage (F) in one embodiment, the resulting mixture from the first stage according to the present invention may be carefully and manually combined with Polymeric Methyl Diisocyanate (Polymeric MDI). The proportion between these two components (mixture resulting from the first stage and polymeric MDI) can vary, allowing customization of the final material according to specific properties required for the application. In particular, as mentioned earlier in this application, the ratio between Polyol and polymeric MDI according to the present invention directly influences the mechanical properties of flexibility, compression resistance, and toughness; it also directly influences the final density of the stave. If there is an excess of Polymeric MDI, the material becomes more porous and therefore more brittle, losing flexibility properties. If there is an excess of Polyol, the stave will be more flexible and will not achieve the desired compression resistance. Based on the above, in one embodiment, Polymeric MDI may be present in a range from 16% to 30%; in another embodiment, Polymeric MDI may be present in a range from 70% to 84%. A person skilled in the art and field to which the invention pertains will be able to envision, based on the teachings of this application, that flexibility in the proportions in which Polymeric MDI can be added, and in principle, the combination of components, as well as the mixing methodology of the first stage, offers precise control over the density, strength, and other mechanical characteristics of the resulting material, which is advantageous for generating a target material formed in a mold, as will be clearer later on. This meticulous and highly adaptable manufacturing process has been designed with the aim of obtaining a synthetic material that surpasses the limitations of current technologies based on conventional wood. By expertly combining the right components and controlling proportions, a material is achieved that offers an exceptional combination of improved mechanical properties and outstanding resistance to challenging environmental conditions, making it a highly effective solution for various industrial and construction applications.

Methodology for Generating a Stave

According to one embodiment, once the resin manufacturing process has been completed as previously described in this application and a high-quality synthetic material mixture has been achieved, the resulting mixture can be poured precisely and meticulously into a specially designed mold.

In one embodiment, the mentioned mold can be made from stainless steel, a material

known for its durability and corrosion resistance, and/or can be made from any other similar and/or suitable material for the aforementioned application.

In a preferred embodiment, the mold has dimensions that can range from ½inch×2″×10″ to a dimension of 6″×20″×40″; more specifically, dimensions that can range from 1″×3″×20″ to 3″×8″×30″; likewise, said mold can have any shape selected from the group comprising squares, rectangles, cylinders, spherical, and/or any regular and/or irregular shape that results in the material being formed with the desired figure for the industrial objective application.

In one embodiment, once the mixture generated according to the present invention has been poured into the aforementioned mold, to facilitate the demolding process without damaging the integrity of the formed material, the stainless steel mold can be meticulously lubricated and can also be covered with wax paper. The wax paper not only prevents the material from adhering to the mold but also provides a smooth and uniform surface to the final product. This is essential to ensure that the synthetic material has a high-quality finish and meets the required specifications.

The final product, which in one exemplary embodiment may be a “stave,” is a versatile component that can be used in a wide range of applications. A prominent example of use is in the manufacturing of specially designed reels for storing electrical cables. Storage reels are critical components in numerous industries, and the incorporation of at least 25 staves in their design is essential to ensure efficient and reliable operation.

These staves provide strength and stability to the reels, which is crucial for keeping electrical cables organized and protected during storage and transportation. The quality and precision in the manufacture of these staves play a key role in the durability and performance of the reels, contributing to the efficient operation of electrical and communication systems in various industrial and commercial applications.

Many modifications and other embodiments of the invention will come to mind to one skilled in the art to which the invention pertains, who has the benefit of the teachings presented in the foregoing descriptions and associated drawings. Therefore, it should be understood that the invention should not be limited to the specific and exemplary embodiments described but is intended that modifications and other embodiments are included within the scope of the appended claims. Although specific terms are used herein, they are used only in a generic and descriptive sense and not for limiting purposes. It should also be understood that the materials with which the various components comprising the invention described herein can be made, the geometries, dimensions, arrangements, and other elements may vary without departing from the scope and spirit of the invention, and therefore, the referred embodiments should not be considered limiting.

### EXAMPLES

### Mechanical Advantages and Strength

The results of the experiments conducted are truly remarkable and demonstrate the

effectiveness of the staves developed according to this invention in terms of mechanical strength. Compression tests revealed that these staves significantly outperform conventional wood in this aspect.

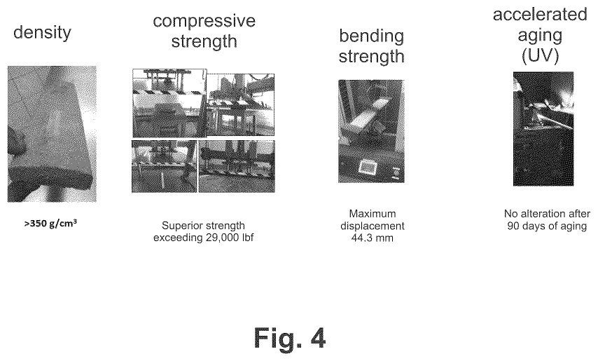

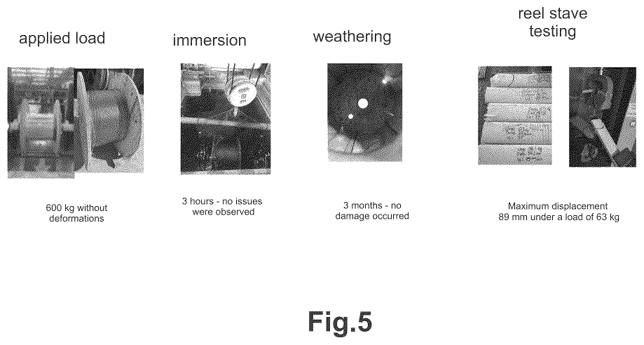

As seen in FIGS. 4 and 5, in compression tests, a maximum force of 29,000 lbf was applied, showing ordinary wood staves (prior art) with evident fracture under such applied force; in contrast, the staves generated according to the present invention did not exhibit fractures under this same amount of force, indicating that they are much more resistant to compression than traditional wood, which did fracture under similar conditions. This finding is crucial as it means that these staves can withstand considerably higher compression loads without damage, making them ideal for applications that demand high strength.

Furthermore, toughness tests revealed that these staves can maintain displacement within necessary parameters while resisting loads. This feature is essential for applications where durability and sustained strength are needed, such as in reels carrying electrical cable.

Referring again to FIG. 4, the test applied for flexural strength shows that the staves generated according to the present invention had a displacement in response to an applied force in a central portion of it according to the table shown below:

TABLE 1
Applied load - displacement ratio of staves
generated according to the present invention.

| # Sample | Load (kgf) | Displacement (mm) |
|---|---|---|
| 1 | 58.2 | 40.9 |
| 2 | 54.8 | 44.3 |
| 3 | 41.1 | 40.6 |

As can be observed and will be evident to a person skilled in the field to which this invention pertains after reading the present disclosure and examining the results of this test, the flexural strength of the board generated by the present invention is advantageously high. This specific mechanical performance is a result of using the resin of the present invention, thus achieving more efficient mechanical performance when using the generated resin, as well as when using the boards generated using said resin.

Finally, once again referring to what is illustrated in FIG. 4, it is observed that after an accelerated aging test using ultraviolet (UV) radiation, in a controlled accelerated aging period of 90 days, the boards of ordinary wood (prior art) showed evident alterations. In contrast, the boards according to the present invention, advantageously, remained intact even under this controlled acceleration process.

In summary, the results of the experiments strongly support that the boards developed in this invention are superior in terms of mechanical strength compared to conventional wood. This makes them an exceptionally suitable choice for applications requiring high compressive strength and toughness, such as reels for carrying electrical cable, where reliability and durability are essential.

### Evaluation of Resistance to Environmental Conditions

To assess the resistance of the boards developed according to this innovation to adverse environmental conditions, comprehensive tests were conducted. These tests covered a wide range of challenging situations. First, weathering tests were carried out, where the boards were subjected to prolonged exposure to adverse weather conditions, including sun, rain, and wind. Despite constant exposure to these natural elements, the boards maintained their integrity and strength, showing no signs of weakness.

Additionally, accelerated aging tests were performed using a UV chamber, where the boards were exposed to intense ultraviolet radiation. These tests simulated long-term aging in a much shorter period. The results revealed that the boards did not suffer any deterioration due to UV exposure and retained their strength.

A third crucial test involved immersing the boards in water to assess their resistance to wet environments and water-associated corrosion. Surprisingly, the boards showed no signs of wear or deterioration after immersion, highlighting their ability to resist wet and corrosive environments.

Also, as seen in FIG. 5, the reel generated according to the present invention, which, as described throughout this disclosure, is generated based on the boards generated according to the present invention, advantageously shows high load resistance. Specifically, achieving a load resistance of 600 kg without any deformation, unlike a reel made of conventional wood (prior art), which under these conditions results in mechanical failure.

With continued reference to FIG. 5, the reel generated according to the present invention, even under corrosive conditions, offers-advantageously-more efficient properties and resistances compared to conventional wood. In this Figure, it is observed that the reel, when submerged in water for a period of 3 hours, was not altered in any way by its contact with the liquid medium. In contrast, conventional wood (prior art), which can be altered relatively quickly (less than 30 minutes even) upon contact with water, significantly alters its mechanical properties. In contrast, the reel according to the present invention was not altered, providing a clear advantage over the use of conventional wood. This same conclusion can be observed by examining the results of the weathering test, in which, after three months of exposure, the reel according to the present invention showed no alteration.

Finally, once the experiments on the reel generated according to the present invention were carried out, each of the boards was dismantled and mechanical tests were applied to observe the mechanical performance. As shown in the table below, advantageously, the boards generated according to the present invention, even when used to form the aforementioned reel and exposed to load and/or corrosive conditions, still retain desirable mechanical properties that conventional wood (prior art) under these same conditions would not possess.

TABLE 2
Load-Displacement Relationship of Boards Generated According
to the Present Invention after being Used to Form the Mentioned
Reel and Exposed to Load and/or Corrosive Conditions.

| # sample | Load (Kg) | Displacement (mm) |
|---|---|---|
| 1 | 51.2 | 64.9 |
| 2 | 66.7 | 86 |
| 3 | 55 | 80.8 |
| 4 | 63 | 89 |
| 5 | 38.1 | 54.2 |

In summary, these comprehensive and varied tests conclusively confirm that the proposed method provides a material with high resistance to corrosive environments. Even under challenging environmental conditions, such as weathering, UV radiation, and water immersion, the boards maintained their integrity and strength. This finding is of great significance as it demonstrates the durability and suitability of this material for a wide range of applications where corrosion resistance is a crucial factor.

1. A coating that mimics wood properties, the coating comprising:
granulated waste material in a percentage from 20% to 60%;
resin in a percentage from 80% to 40%;
wherein;
the granulated waste material is micrometric wood sawdust; and
the resin is a polyurethane-based resin.

2. The coating according to claim 1, wherein the polyurethane-based resin is formed from materials and components selected from the group consisting of: Polyethylene Glycol, inorganic fillers such as calcium hydroxide (CaOH), Kaolin, Calcium Carbonate (CaCO3);
defoamer, and a catalyst, Polymeric Methyl Diisocyanate (Polymeric MDI) and MDI Polymeric, combinations thereof, and/or the like.

3. The coating according to claim 1, wherein the Polyethylene Glycol present in the polyurethane-based resin is Polyethylene Glycol with a molecular weight of approximately 300, approximately 600, and/or approximately 1000 g/mol.

4. The coating according to claim 1, wherein the polyurethane-based resin comprises inorganic fillers in a range of 10% to 30%, and said inorganic fillers are any selected from the group consisting of calcium hydroxide (CaOH), Kaolin, Calcium Carbonate (CaCO3), combinations thereof, and/or the like.

5. The coating according to claim 1, wherein the polyurethane-based resin includes a defoamer and a catalyst, the defoamer being any selected from the group comprising silicone-based and polysiloxane emulsions, and the catalyst is any selected from the group comprising organometallic, amino, and metal-free organic types.

6. The coating according to claim 1, wherein the polyurethane-based resin further comprises Polymeric Methyl Diisocyanate (Polymeric MDI).

7. The coating according to claim 5, wherein the defoamer is present in an amount and/or proportion less than 1%, for example, in a proportion of approximately 1%, approximately 0.90%, approximately 0.80%, approximately 0.7%, approximately 0.6%, approximately 0.5%, approximately 0.4%, approximately 0.3%, approximately 0.2%, approximately 0.1%, or even less than 0.1%.

8. The coating according to claim 5, wherein the catalyst is present in an amount and/or proportion less than 1%, for example, in a proportion of approximately 1%, approximately 0.90%, approximately 0.80%, approximately 0.7%, approximately 0.6%, approximately 0.5%, approximately 0.4%, approximately 0.3%, approximately 0.2%, approximately 0.1%, or even less than 0.1%.

9. The coating according to claim 5, wherein the catalyst is in the same amount and/or proportion as the defoamer.

10. The coating according to claim 5, wherein the catalyst is in an entirely different amount and/or proportion from that of the defoamer.

11. The coating according to claim 6, wherein the polyurethane-based resin comprises Polymeric Methyl Diisocyanate (Polymeric MDI) in a proportion ranging from 16% to 30% and/or from 70% to 84%.

12. A method for manufacturing the coating according to claim 1, the method comprising the steps of:
a first stage, which in turn comprises the steps of:
A) preparing a mixture in a closed container with controlled vacuum, comprising Polyethylene Glycol and waste material;
B) adding inorganic fillers in a proportion ranging from 10 to 30%;
C) adding a defoamer in an amount and/or proportion less than 1%, for example, in a proportion of approximately 1%, approximately 0.90%, approximately 0.80%, approximately 0.7%, approximately 0.6%, approximately 0.5%, approximately 0.4%, approximately 0.3%, approximately 0.2%, approximately 0.1%, or even less than 0.1%;
D) adding a catalyst in an amount and/or proportion less than 1%, for example, in a proportion of approximately 1%, approximately 0.90%, approximately 0.80%, approximately 0.7%, approximately 0.6%, approximately 0.5%, approximately 0.4%, approximately 0.3%, approximately 0.2%, approximately 0.1%, or even less than 0.1%;
E) subjecting the resulting mixture from steps A-D to high-speed agitation, particularly agitation in a speed range from 700 rpm to 1200 rpm for a period ranging from two to eight hours;
a second stage, comprising the steps of:
F) combining the resulting mixture from step E with Polymeric Methyl Diisocyanate (Polymeric MDI) in such a proportion that the Polymeric MDI is present in a range ranging from 16% to 30% and/or from 70% to 84%.

13. The method according to claim 12, wherein Polyethylene Glycol has a molecular weight in a value of approximately 300, approximately 600, and/or approximately 1000 g/mol.

14. The method according to claim 12, wherein the waste material, particularly sawdust, is in a proportion ranging from 20% to 60%.

15. The method according to claim 12, wherein the inorganic fillers are any selected from the group consisting of calcium hydroxide (CaOH), Kaolin, Calcium Carbonate (CaCO3), combinations thereof, and/or the like.

16. The method according to claim 12, wherein the defoamer is any selected from the group comprising silicone-based and polysiloxane emulsions, and the catalyst is any selected from the group comprising organometallic, amino, and metal-free organic types.

17. The method according to claim 12, wherein the catalyst is in the same amount and/or proportion as the defoamer.

18. The method according to claim 12, wherein the catalyst is in an entirely different amount and/or proportion from that of the defoamer.

19. A method for manufacturing a synthetic material, the method comprising the steps of:
performing the steps of claim 12; and then
i) lubricating a mold, and
ii) pouring the coating into the mold.

20. The method according to claim 19, further comprising covering the mold with waxed paper.

21. The method according to claim 19, wherein the mold has dimensions ranging from ½ inch×2″×10″ to a dimension of 6″×20″×40″, and said mold has any shape selected from the group consisting of squares, rectangles, cylinders, spherical, and/or any regular and/or irregular shape that results in the material formed with the desired figure.
